(19) United States
(12) Patent Application Publication
(10) Pub. No.: US 2005/0030036 A1
(43) Pub. Date: Feb. 10, 2005

(54) Side entry leak protection for sondes

(75) Inventors: James C. Hunziker, New Caney, TX (US); Borislav Tchakarov, Katy, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: Baker Hughes Incorporated, Houston, TX (US)

(21) Appl. No.: 10/635,250

(22) Filed: Aug. 6, 2003

(51) Int. Cl. G01V 3/18

(52) U.S. Cl. 324/338; 324/323; 73/431

(57) ABSTRACT

Devices and methods for construction of a sonde or other sensing tool that includes a side-entry leak protector arrangement. The side-entry leak protector provides for improved fluid sealing against fluid that might enter a sonde sub proximate the side-mounted sensor component. The side entry leak protector connector assembly includes a metal body with glass-sealed conductive elements and pin connectors to operably engage mating electrical connections leading to the sensor element, or elements, and to the components housed within the sub. The outer radial body of the protector connector assembly provides an annular fluid chamber to permit fluid that might enter the sub to reside therewithin. The outer radial body of the protector connector assembly also includes O-ring seals that provide fluid sealing between the protector connector assembly and the interior walls of the sub.

### BACKGROUND OF THE INVENTION

1. Field of the Invention

The invention relates generally to the design and construction of electrical connections for use in sondes and similar wellbore logging tools. In particular aspects, the invention provides devices and methods for improved packaging of electrically conductive elements within such a tool and for protecting said elements against wellbore fluids.

2. Description of the Related Art

A number of tools are known today for logging or sensing conditions within a wellbore during various portions of the well productions process. These sensing tools, or sondes, include an outer casing or sub that is often disposed into a wellbore on wireline. Alternatively, the sub may be disposed into the wellbore on coiled tubing or as part of the drill string or even production tubing. The sensing tools are capable of detecting a wide variety of downhole conditions, including temperature, pressure, porosity, resistivity, and so forth. The sensing tool generally features a sensor disposed on the outer side surface of the sub or embedded therewithin the side surface. Electronic equipment is disposed within the interior of the sub, and is typically contained within compartments behind sealed bulkheads that are located proximate each axial end of the sub. This electronic equipment typically includes processing circuitry, storage media, and power sources.

Fluid sealing is provided around the sensor to prevent entry of fluid into the interior of the sub. If damaged, however, the seal may permit fluid to flow into the interior of the sub. A typical external environment for a sonde would be one where the wellbore fluid is at a pressure state that higher than the interior of the sub. The pressure difference may range from 50 psi to 30,000 psi. Once inside the sub, the fluid may corrode or otherwise destroy the conductivity of the wiring that extends between the sensor and the components housed within the two axially-located chambers. Additionally, if either of the bulkheads are breached, the intruding fluid might easily destroy the electronic components housed within. Additionally, present techniques for constructing sondes with bulkheads and the necessary bulkhead electrical connectors are time consuming and costly.

The present invention addresses the problems of the prior art.

### SUMMARY OF THE INVENTION

The invention provides devices and methods for construction of a sonde or other sensing tool that includes a side-entry leak protector connector arrangement. The side-entry leak protector connector provides for improved fluid sealing against fluid that might enter a sonde sub proximate the side-mounted sensor component. An exemplary side entry leak protector connector assembly is described having a metal body that is secured within a passage within the sub. The side entry leak protector connector assembly includes glass-sealed conductive elements and pin connectors to operably engage mating electrical connections leading to the sensor element, or elements, and to the components housed within the sub. The outer radial body of the protector connector assembly provides an annular fluid chamber to permit fluid that might enter the sub to reside therewithin. The outer radial body of the protector connector assembly also includes O-ring seals that provide fluid sealing between the protector connector assembly and the interior walls of the sub. The protector connector assembly eliminates the need for interior bulkheads within the sub.

In alternative embodiments, the side entry leak protector connector assembly includes an axial passage for cables and other components to be fed through.

### BRIEF DESCRIPTION OF THE DRAWINGS

FIG. 1 depicts an exemplary wireline-run sonde within a wellbore.

FIG. 2 is a side, cross-sectional view of an exemplary sonde, which incorporates a side entry leak protector connector assembly constructed in accordance with the present invention.

FIG. 2A is an enlarged cross-sectional view of side entry leak protector connector assembly shown apart from other components.

FIG. 3 is a side, cross-sectional view illustrating sonde with an alternative side leak protector connector assembly constructed in accordance with the present invention.

FIG. 4 is a side-cross sectional view of a further alternative sonde constructed in accordance with the present invention, and also containing a side leak protector connector assembly.

### DETAILED DESCRIPTION OF THE PREFERRED EMBODIMENTS

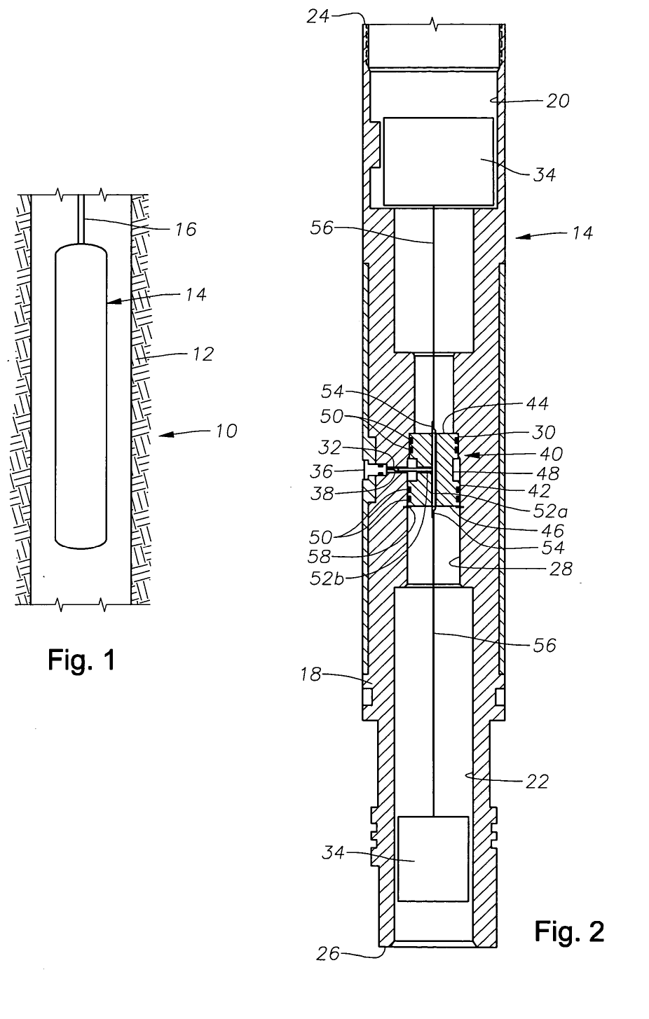

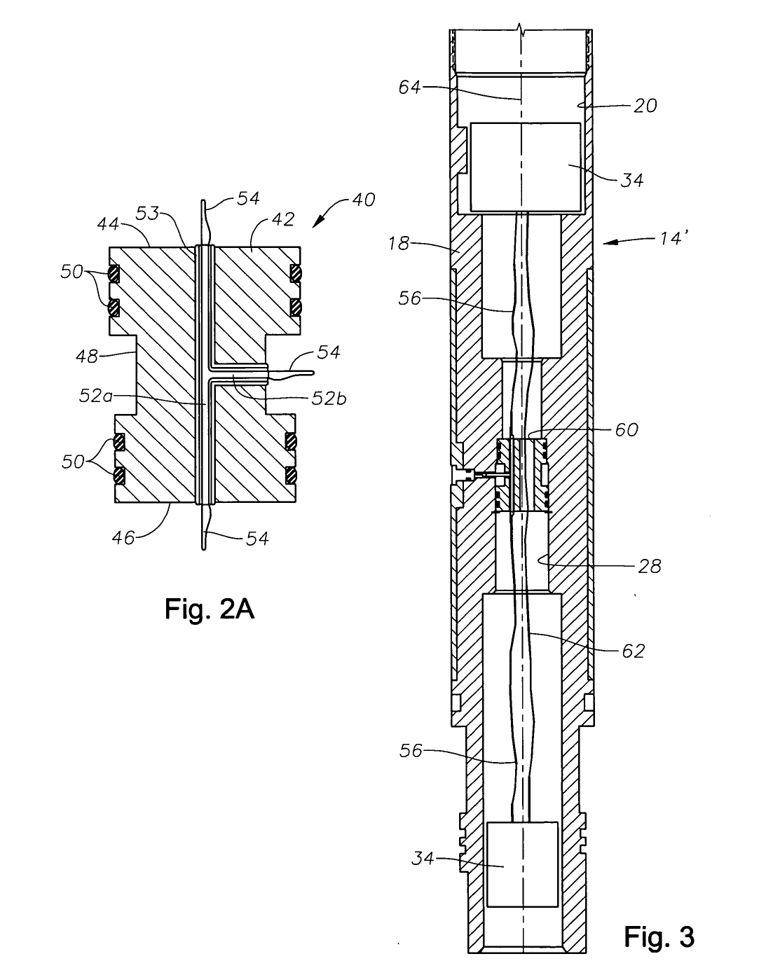

FIG. 1 schematically illustrates a downhole portion of a wellbore 10 that is disposed through earth 12. A sonde 14 is suspended upon a wireline running arrangement 16 within the wellbore 10, which also contains a variety of fluids to which the sonde 14 will be exposed. The sonde 14 may be configured to detect any of several known downhole conditions, including resistivity, porosity, pressure, temperature, and so forth. The sonde 14 is shown in cross-section in FIG. 2. The sonde 14 has a tubular outer housing 18 which defines a pair of chambers 20, 22 which are located proximate each axial end 24, 26, respectively. An axial passage 28 extends between the two chambers 20, 22. The axial passage 28 includes a shoulder 30. A lateral opening 32 interconnects the axial passage 28 to the radial exterior of the sonde 14.

Electronic equipment 34 is contained in each of the chambers 20, 22. The electronic equipment 34 may include processing circuitry, power sources, storage media or the like. Additionally, a sensor 36 for detecting a downhole condition is mounted on the exterior of the housing 18 and provides an electrical pin connector 38 that is disposed within the lateral opening 32.

A side entry leak protector connector assembly is shown generally at 40 in FIG. 2. FIG. 2A depicts the side entry leak protector connector assembly 40 in greater detail and apart from other components of the sonde 14. The protector connector assembly 40 includes a metallic body 42 that is generally cylindrical in shape, having two axial ends, 44, 46. A circumferential channel 48 surrounds the body 42 at a central point along its length. A pair of O-ring seals 50 is located on either side of the channel 48 to preclude any fluid that actually enters the channel 48 from escaping to either axial side of the assembly 40. Fixedly retained with the body 42 are glass sealed conductive elements 52a and 52b with external pin-type electrical connectors 54. As FIG. 2A shows, the glass sealant 53 surrounds each of the elements 52a, 52b and fills the interstitial spaces between the elements 52a, 52b and the metallic body 42. FIG. 2A also illustrates the presence of pin-type electrical connectors 54 that project outwardly from the body 42. In FIGS. 2 and 2A, there are two conductive elements 52a, 52b shown. However, the number and arrangement of conductive elements will depend upon the number of electrical connections to be made by the protector connector assembly. The first conductive element 52a extends axially through the body 42 and the second element 52b extends radially outwardly from the first conductive element 52a. The second conductive element 52b engages the electrical pin connector 38 for the sensor 36. Meanwhile, the pin type connections 54 of the first conductive element 52a are electrically connected to wires 56 that interconnect the protector connector assembly 40 with the electrical equipment 34 in each of the chambers 20, 22.

The protector connector assembly 40 resides within the axial passage 28 so that one axial end 44 of the protector connector assembly 40 abuts the shoulder 30 of the passage 28. A snap ring 58 retains the protector connector assembly 40 within the passage 28.

In operation, the side entry leak protector connector assembly 40 provides superior prevention of and protection against fluid that might enter the housing 18 via the lateral opening 32. The circumferential channel 48 contains any fluid that might enter the lateral opening 32. In addition, the O-ring seals 50 provide a secondary seal against fluid ingress past the protector 40 and into the chambers 20, 22. This eliminates or reduces the need for bulkheads to be constructed within the housing 18 to seal off the chambers 20, 22 from the axial passage 28. Additionally, the glass-sealing of the conductive elements 52a, 52b within the body 42 prevents damage to the conductive elements 52a, 52b from borehole fluids.

FIG. 3 illustrates a further sonde 14′ that contains an alternative leak protector connector assembly 40′. The leak protector connector assembly 40′ differs from the leak protector connector assembly 40 by the inclusion of an axial passage 60 through which wiring or cables 62 may be disposed. It is noted that the axial passage 28 is mounted off-center within the housing 18 of the sonde 40″ so that the central axis of the passage 28 is not coincident with the axis 64 of the housing 18. The wiring 62 is used to interconnect the electronic equipment 34 in each of the two chambers 20, 22. The sonde 14″ is typically used where also wires 62 are required for application in between modules of tool string. In that instance, the wires 62 would merely extend beyond the axial ends 24, 26 of the housing 18 to neighboring modules (not shown).

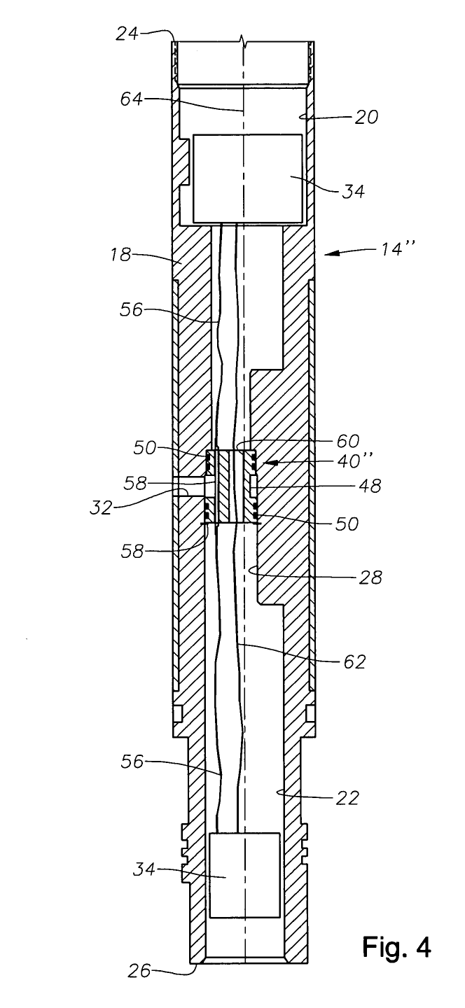

FIG. 4 depicts a further alternative sonde 14″ which also incorporates a side entry leak protector connector assembly 40″ in accordance with the present invention. In this arrangement, the protector connector assembly 40″ carries a direct contact electrode 58 that is exposed to wellbore fluids through the lateral opening 32. A direct contact electrode is used in a number of sondes, including an induction tool. It is noted that, in this embodiment, the opening 32 is not blocked or sealed against entry of fluids. The electrode 58 is positioned within and upon the circumferential channel 48 so that fluid entering the opening 32 will reside within the channel 48. The o-ring seals 50 on each side of the channel 48 block fluid passage from the channel 48 into the axial passage 28. This particular embodiment is useful where the sonde 14″ is a larger diameter sonde or where it is desired to position the direct contact electrode 58 very proximate the outer radial diameter of the housing 18. Because the side entry leak protector assemblies 40, 40′ and 40″ can be used for both small and large diameter sondes, they can be economically manufactured in a single size and interchangeably used in sondes of different diameters.

In practice, the arrangements of the present invention provide for superior leak protection as well as ease of establishing electrical connectivity between sensors and electrical components 34 that are housed within the sonde housing or in neighboring housings.

Those of skill in the art will recognize that numerous modifications and changes may be made to the exemplary designs and embodiments described herein and that the invention is limited only by the claims that follow and any equivalents thereof.

1-8. (Cancelled)

9. A sonde comprising:
an outer housing;
an electrical device operably associated with the housing;
a side entry leak protector connector assembly retained within the housing and comprising:
a generally cylindrical body with a pair of axial ends;
a conductive element retained within the body, interconnected with the electrical device and extending through at least one of said axial ends; and
sealing encasing said conductive element within the body to electrically isolate the conductive element.

10. The sonde of claim 9 further comprising an electrical pin connector associated with said conductive element, for electrically connecting the conductive element with an external conductor.

11. The sonde of claim 9 further comprising a circumferential channel surrounding the body for capturing fluid therewithin.

12. The sonde of claim 11 further comprising a pair of o-ring seals disposed upon the body to preclude escape of fluid from the channel.

13. The sonde of claim 9 wherein the outer housing defines two interior chambers for housing electronic components and an axial passage that interconnects the two chambers and wherein the side entry leak protector connector assembly is retained within the axial passage.

14. The sonde of claim 13 wherein the housing defines a lateral passage from the axial passage to an exterior radial surface of the housing.

15. The sonde of claim 11 wherein a sensor element is disposed within the channel.

16. The sonde of claim 13 wherein the axial passage is defined off-center from a central axis of the sonde housing.

17. A method of providing fluid sealing and electrical connections within a sonde having an interior chamber within comprising the steps of:
providing a first electronic component within the interior chamber;
associating a second electronic component with an exterior of the sonde; and
connecting the first and second electronic components through a side entry leak protector connector assembly.

18. The method of claim 17 further comprising the step of establishing an electrical connection between the sensor component and the side entry leak protector connector assembly.

19. The method of claim 18 further comprising the step of establishing an electrical connection between the side entry leak protector connector assembly and an electronic component housed within the interior chamber.

20. The method of claim 17 further comprising the step of providing a circumferential channel about the body of the side entry leak protector connector assembly for capturing of fluid.

21. The method of claim 17 wherein the second electronic component comprises a sensor.

22. A side entry leak protector connector assembly comprising:
a generally cylindrical body having two axial ends and a radial outer surface;
a conductive element that is electrically isolated and sealed within the body, the conductive element providing a first electrical interconnection at the radial outer surface and a second electrical connection at an axial end.

23. The side entry leak protector connector assembly of claim 22 wherein the body includes a circumferential channel.

24. The side entry leak protector connector assembly of claim 22 wherein the body further defines an axial passage through which additional wiring may be disposed.

25. The side entry leak protector connector assembly of claim 22 wherein the conductive element is electrically isolated and sealed within the body by glass-sealing.

26. The side entry leak protector connector assembly of claim 22 further comprising a sensor disposed upon the radial outer surface of the body and in electrical connection with the first electrical interconnection.

27. The side entry leak protector connector assembly of claim 22 further comprising an o-ring seal upon the outer radial surface of the body.
